(19) United States
(12) Patent Application Publication
(10) Pub. No.: US 2005/0187742 A1
(43) Pub. Date: Aug. 25, 2005

(54) Physics engine

(76) Inventor: David J. Collodi, Taylorville, IL (US)

Correspondence Address: BRINKS HOFER GILSON & LIONE, P.O. BOX 10395, CHICAGO, IL, 60610, US

(21) Appl. No.: 10/782,745

(22) Filed: Feb. 19, 2004

(51) Int. Cl. G06F 17/10

(52) U.S. Cl. 703/2

(57) ABSTRACT

The present invention is directed to a method of simulating the physical dynamics of a predetermined set of objects that are part of a computer/video game. The objects are connected to each other at one or more respective links. The method of the invention includes the step of grouping a first and a second object in the predetermined set of objects to define a first binary object. A solution for the physical dynamics of the objects in the first binary object at a first link is solved. A third object is grouped to the first binary object to define a second binary object. The third object has at least one link to the first binary object thereby defining a second link. A solution for the physical dynamics of the objects in the second binary object at the second link is solved. Additional objects are recursively grouped to create additional binary objects and the physical dynamics of the additional binary objects is solved.

### FIELD OF THE INVENTION

The present invention relates to the calculation of the physical dynamics of a video/computer game. More particularly, the present invention relates to an improved physics engine that provides a more efficient process with heightened realism.

### BACKGROUND OF THE INVENTION

The design of a real-time video/computer game is full of challenges. One of them is developing an efficient and realistic approach to calculation of the physical dynamics of the game. Real time games demand the most from the processor of a computer. The calculations required to conduct the game demand the most from even the faster game processors available. For example, the calculation of physical dynamics of a game environment can result in lengthy computations. This is particularly true where the game involves multiple interacting objects. Where compromises are required, many conventional games tend to provide simplified approaches to the calculation of the physical dynamics or physics of the game. However, these compromises often lead to a game that can lack realism.

Enhancing the realism, and particularly the physical dynamics of a game is often not straightforward. The implementation of a sophisticated and robust physics engine presents a number of technical challenges which have not been entirely overcome by prior art approaches. Some approaches use linear and quadratic programming to minimize sets of functions, while other approaches employ pivoting techniques from linear complementary problems to obtain solutions. These techniques, however, suffer from a high order solution complexity and runtime and are, therefore, only applicable to video games in a limited sense. Other approaches have involved the use of simplified physics engines which require fewer computations, but come at the expense of a more realistic game experience. Even inexperienced game players may find that a simplified approach to physical dynamics results in a relatively artificial game experience.

Therefore, there is a need for a physics engine capable of providing a computationally efficient process while not sacrificing the realism of the game environment.

### SUMMARY OF THE INVENTION

The present invention is directed to a method of simulating the physical dynamics of a predetermined set of objects that are part of a computer/video game. The objects are connected to each other at one or more respective links where some of the links represent hard contact between separate objects. The steps of the invention include creating a nested grouping of a plurality of binary objects. The objects are defined by a plurality of polygons. Starting with the most deeply nested binary object and proceeding outward, a solution is solved for the physical dynamics of the objects in the binary objects at the respective links.

A further aspect of the invention involves solving a constrained solution for the physical dynamics of a set of objects connected to each other at one or more respective links. One or more link weight values are assigned to each link such that the link weight values constrain the solution. A first iterative solution is then solved for the dynamics of the objects using the weight values. The link weight values are then adjusted for links which violate the solution constraints. Multiple solution iterations are then performed with one or more link weight values adjusted at each iteration until the solution conforms to the constraints within a predetermined acceptable tolerance.

An additional aspect of the present invention is directed to a video game system with improved physical dynamics comprising a binary division unit operable to create a nested grouping of binary objects from a set of objects connected by one or more respective links. The video games system further comprises a dynamics unit with one or more processors operable to solve a solution for the physical dynamics of the objects.

It should be recognized that the steps of the present invention may be practiced in an order other than that identified in the claims. Accordingly, the order of the steps in the method claims provided herein should not be construed as in any way limiting the steps of the present invention to a particular order.

### BRIEF DESCRIPTION OF THE DRAWINGS

FIG. 1 is a diagram illustrating an embodiment of the invention having a set of connected objects;

FIG. 2 is a diagram illustrating an embodiment of the invention with two connected objects and illustrating the link therebetween;

FIG. 3 is a diagram illustrating an embodiment of the invention with a plurality of objects and links therebetween;

FIG. 4 is a diagram illustrating an embodiment of the invention having a binary object;

FIG. 5 is a diagram illustrating an embodiment of the invention with a set of objects having a plurality of links;

FIG. 6 is a diagram illustrating an embodiment of the invention with a plurality of binary objects;

FIG. 7 is a diagram illustrating an embodiment of the invention having a single binary object formed from a plurality of sub-objects;

FIG. 8 is a logic diagram illustrating a game according to an embodiment of the present invention; and

FIG. 9 is a logic diagram illustrating a dynamics subsystem according to an embodiment of the present invention.

### DETAILED DESCRIPTION OF THE DRAWINGS AND THE PRESENTLY PREFERRED EMBODIMENTS

The advantages of using a robust physical dynamics system within a video game are numerous and represent a major improvement over prior art systems. Many different types and genres of video games stand to benefit from improved physical dynamics simulations. For example, a car racing game could be improved by simulating the physical dynamics of the various game objects. Gravity and friction can be used to accurately simulate the behavior of the cars, leading to a more realistic experience as well as enabling more complex interactions such as cars driving on top of one another. Likewise, a football game could be created with accurate physical interaction between the players. Most current football games use a limited number of pre-recorded animations to depict games events such as tackles. A football game coupled with a sophisticated dynamics system, however, could use the physical dynamics to simulate tackles “on the fly,” leading to a limitless number of different possibilities and an enhanced sense of realism.

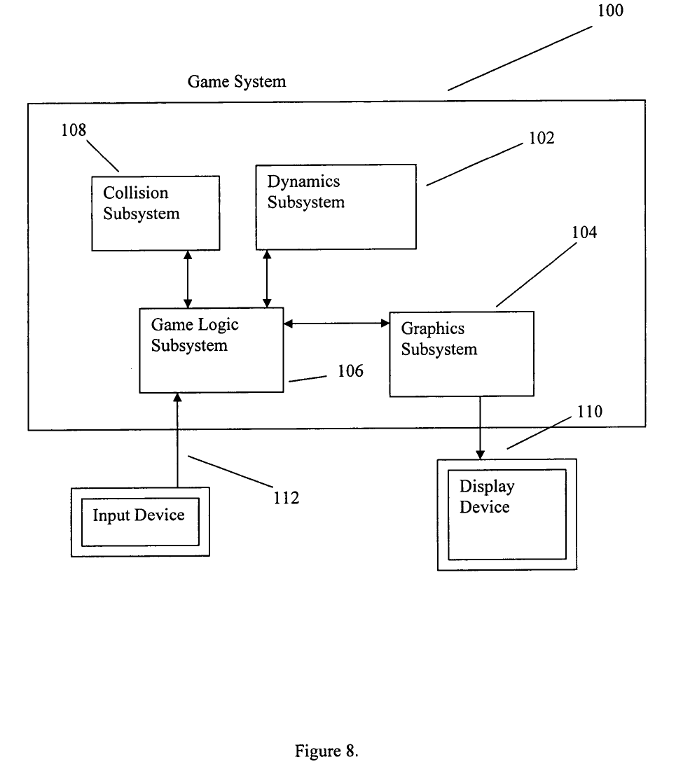

The present invention comprises a video game/simulation system with improved physical dynamics interactions among sets of objects. FIG. 8 illustrates a high-level view of said game system 100. A game logic subsystem at 106 handles game-specific processing tasks such as implementation of game rules, character movement and artificial intelligence. Input commands from an input device are sent to the game logic subsystem at 112. A graphics subsystem at 104 is operable to generate game specific images such as characters and backgrounds wherein said images are output to a display device at 110. A collision subsystem at 108 handles the processing of collision detection between various game objects. A dynamics subsystem at 102 operatively resolves collision and constraint violations between connected sets of game objects in an improved manner. In order to illustrate the functionality of the dynamics subsystem of the present invention, methods and practices novel to said dynamics system shall first be defined in relation to the attached illustrations.

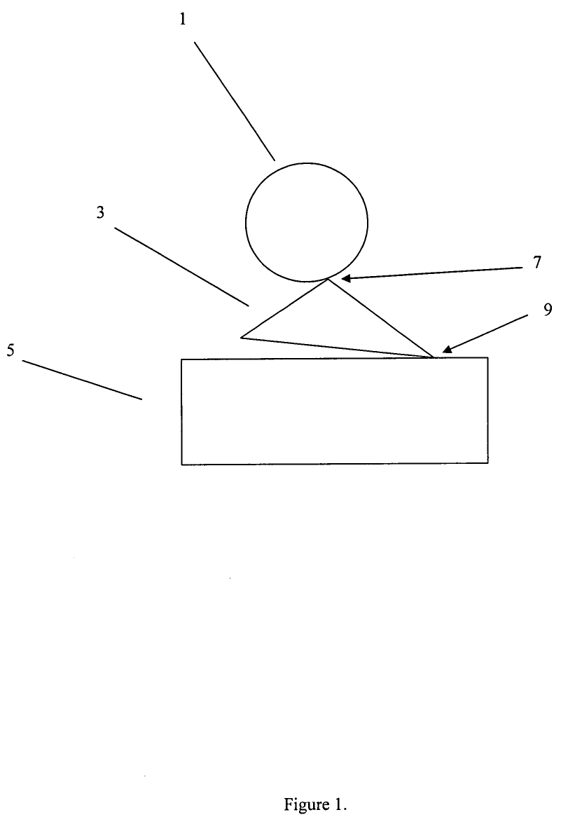

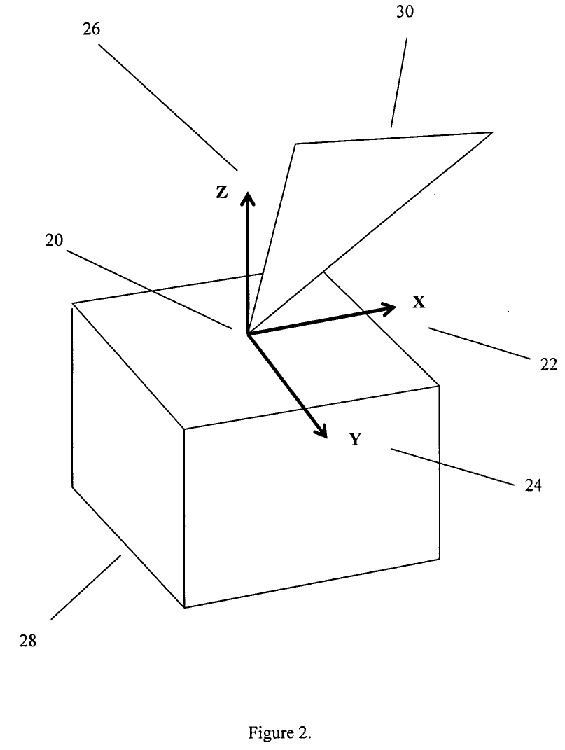

FIG. 1 shows an example of a connected set of objects. Objects at 1, 3, 5 are connected by links at 7, 9. The term link will henceforth be defined as a set of data representing a connection between two objects. Typically, a link will represent a single point of physical contact between the objects. Therefore, each link includes a position represented by a 3-dimensional vector which defines the point of contact. Each link also has a link orientation defined by three unit-length orthogonal axis vectors (X, Y, and Z). FIG. 2 illustrates a link 20 and the associated link orientation X 22, Y 24, and Z 26 axis vectors. Furthermore, each link contains references to both of the connected objects wherein one of the objects is considered to be the front object and the other the back object. The link orientation Z axis is always coincident to the surface normal (at the point of contact) of the front object. The front object, therefore, defines the contact orientation. In FIG. 2, the object at 28 is the front object whereas the object at 30 is the back object. While the link orientation Z vector is defined by the front object surface normal, the corresponding X and Y vectors are arbitrary within the constraint that they must be perpendicular to the Z vector and to one another. Advantages sometimes exist, however, in using more than just the two (X, Y) vectors perpendicular to the normal (Z) vector. The description presented herein details the use of the X and Y direction vectors primarily for the purpose of example and is not intended to limit the scope of the present invention to the use of a set number of orientation vectors.

The link delta, D, represents the relative speeds of the front and back object at the point of contact. Where V_{front} and V_{back} are 3-dimensional vectors representing the velocities of the front and back objects (at the point of contact) relative to the link orientation, link delta, D, is calculated by:
D=V_{front}=V_{back} (1)

A link is considered broken when the z-coordinate of the D vector is greater than zero. A broken link indicates that the objects are about to interpenetrate unless the velocities of the objects are changed.

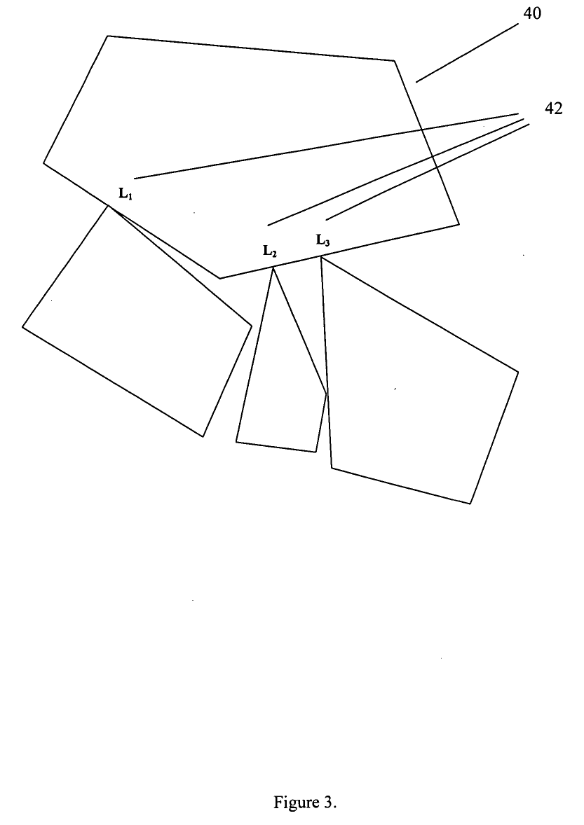

A typical connected set of objects is depicted in FIG. 3. Each object in a connected set will contain one or more links, denoted by the set L₁ . . . Lₙ. The object at 40 contains three links: L₁, L₂, and L₃ 42. Object links are the primary input/output mechanism for the physics system of the present invention. Many prior art dynamics systems treat objects exclusively as rigid bodies which are capable of rotation and movement. Treating objects as rigid bodies can be advantageous mathematically since the equations of motion are consistent among all objects in a set, a fact which can be exploited to streamline solutions. Conversely, use of a rigid body system can also limit the types of behaviors and interactions capable of being simulated-by such a system. A key aspect of the present invention is that it provides a dynamics system for solving interactions between a set of objects without requiring any explicit foreknowledge of the behavior characteristics of each object. Each object is therefore free to implement its own unique behaviors (i.e., rigid body, soft body, immobile etc.) while being assured of proper interaction with other objects and proper manipulation by the dynamics system of the present invention.

In order to implement the above mentioned object polymorphism, each object must expose two properties to the dynamics system, velocity and reaction. An object's velocity is defined as an array (set) of three-dimensional velocity vectors V[1] . . . V[n] where n is the number of links in the object. Each member of the velocity set, V[x], is defined as the three-dimensional velocity of the object at the position of Lₓ relative to the link orientation of Lₓ. The object reaction is defined as the change of object velocity when a specific three-dimensional impulse vector, I, is applied at Lₓ and is represented by an array of three-dimensional vectors R¹ₓ[1] . . . R^{I}ₓ[n] where n is the number of links. Each element of the reaction array, R^{I}ₐ[b], is defined as the difference in V[b] before and after impulse I is applied to the object at the point of Lₐ such that:
R^{I}ₐ[b]=V′[b]−V[b] (2)
where V[b] is the original velocity value and V′[b] is the value of V[b] after impulse I has been applied to the object at the point of Lₐ. The reaction and velocity arrays allow an object to supply behavioral information in a general way to the dynamics system thereby insuring interoperability between objects of varying behavioral characteristics. As an example, consider a deformable object such as a water balloon. The reaction of the water balloon object (to a specific force) would reflect the change of velocity due to both the deformation and the movement of the object (since both would be affected by the force). Likewise, consider a second object that is solid. The reaction of the solid object only reflects the movement of the object by the applied force. When the solid object and the water balloon collide, the force of the collision will result in the solid object moving and the water balloon deforming as expected. Likewise, if two water balloons collide, both will be moved and deformed. Furthermore, consider a third object that is a multi-jointed character, such as a person. The reaction of the character object reflects movement of the internal joints as well as the object as a whole. Since the physics engine is doing the same thing in any case (applying force based on the reaction values), it is able to resolve collisions or interactions between any of the object types (character, water balloon, and solid).

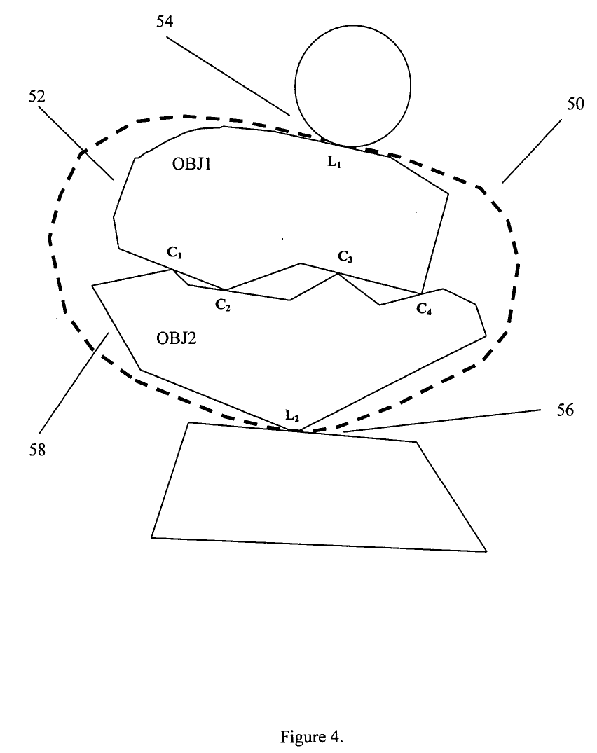

The term binary object, as used herein, refers to a special type of object used by the dynamics system of the present invention. FIG. 4 illustrates a typical binary object 50. A binary object always comprises two linked (touching) sub-objects, OBJ1 52 and OBJ2 58. Binary objects have two distinct types of links: external links and cross links. The external links 54, 56, labeled L_{I} . . . Lₙ, represent the points of contact between a sub-object and an external object. The cross links, labeled C₁ . . . Cₙ, represent the points of contact between the two sub-objects.

When any of the cross links of a binary object are broken, the binary object may be solved in order to resolve the broken cross links. Solving a binary object involves finding a set of impulse vectors, I[1] . . . I[n], which, when applied to the sub-objects at the cross links (i.e., I[1] is applied at C₁, I[2] at C₂, etc.) will ensure that the z component of each cross link delta is less than or equal to zero. The process of determining the correct impulse set essentially involves solving a system of simultaneous linear equations based on the initial delta values and the sub-object reactions. Since, however, simultaneous linear equations are most efficiently solved to zero, the present invention introduces a solution method that allows the controlled solution of linear equation sets to zero and non-zero values while retaining the complexity of solve-to-zero methods.

A preferred embodiment of the above mentioned solution method for the determination of an impulse set is detailed below. The relevant initial delta values are stored in array d (d[1] . . . d[n] where n is the number of cross links) wherein each element is defined as:
d[x]=Cₓ.D·Cₓ.Z (3)
where Cₓ.D is the delta value and Cₓ.Z is the link orientation z-axis vector for cross link Cₓ. A scalar weight value for each cross link is stored in array w (w[1] . . . w [n]) where each weight value is between zero and one. For the sake of example, it should be assumed that the sub-object's links are numbered to correspond to the cross links—i.e., L₁ for OBJ1 (OBJ1 .L₁) should be equivalent to C₁ and so on. Furthermore, it is herein assumed that the negation of a vector represents a component-wise negation—i.e where K=<K.x, K.y, K.z>, −K=←K.x, −K.y, −K.z>. A combined reaction value array, B[1 . . . n,1 . . . n], is used to represent the difference in z-axis reaction from the front and back objects at each cross link where:
B[x,y]=(FrontOBJ.R^{-Cx.Z}ₓ[y]−BackOBJ.R^{Cx.Z}ₓ[y])·C_{y.}Z (4)
Arrays A, J and k are further used in the determination of an impulse set and are recursively defined herein as follows:

$$\begin{matrix}\begin{matrix}A [ p , q , r ] = J [ p , q ] \cdot A [ p - 1 , p , r ] + A [ p - 1 , q , r ] \text{:} & p > 0 , q > p\end{matrix} & ( 5 ) \\ A [ 0 , p , q ] = B [ p , q ] & ( 6 ) \\ \begin{matrix}A [ p , p , q ] = J [ p , p ] \cdot A [ p - 1 , p , q ] \text{:} & p > 0\end{matrix} & ( 7 ) \\ A [ 0 , 0 , p ] = 0 & ( 8 ) \\ \begin{matrix}J [ p , q ] = - w [ p ] \cdot \frac{A [ p - 1 , q , p ]}{A [ p - 1 , p , p ]} \text{:} & p > 0 , q > p\end{matrix} & ( 9 ) \\ \begin{matrix}J [ p , p ] = - w [ p ] \cdot \frac{d [ p ] + A [ p - 1 , p - 1 , p ]}{A [ p - 1 , p , p ]} \text{:} & p > 0\end{matrix} & ( 10 ) \\ \begin{matrix}k [ p ] = J [ p , p ] + {\sum }_{q ← p + 1}^{n} ( J [ q , q ] \cdot J [ p , q ] ) \text{:} & 1 \leq p < n\end{matrix} & ( 11 ) \\ \begin{matrix}k [ p ] = J [ p , p ] \text{:} & p = n\end{matrix} & ( 12 )\end{matrix}$$

The final values for each member of the above mentioned impulse vector set are then determined by:
I[x]=k[x]·C_{.x}.Z (13)
The impulse vector set, I[1] . . . I[n], once determined, represents a unique solution for the initial cross link delta set, d[1] . . . d[n]. The topography of the solution is controlled by the weight values for each link (w[1] . . . w[n]) such that links with a weight value of one are ensured to have a substantially zero z-axis delta value when the solution set is applied, whereas links with weight values less than one may have a non-zero delta value. Furthermore, links having a weight value of zero shall have no impulse applied, i.e., if w[x]=0, then the length of I[x] must be zero. In a general sense, a link weight, for the purposes of a linear equation solver, independently scales the solution of a link between zero and the value required to completely solve the system of equations. Those in the art may recognize that, with all weight values set to one, the above detailed solution method is functionally equivalent to standard solution methods for linear equation sets that are well known in the art. Indeed, the use of any method for the solution of a binary object is within the scope of the present invention provided that the behavior of said method is properly modified to incorporate link weights as detailed above.

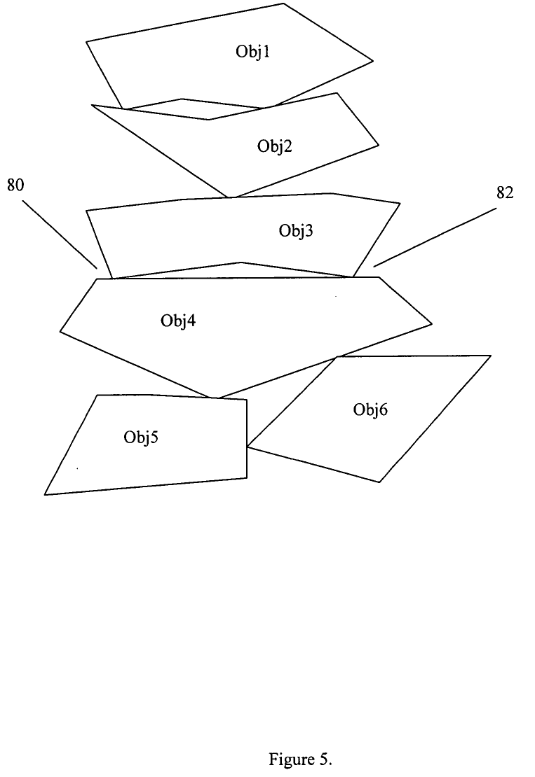

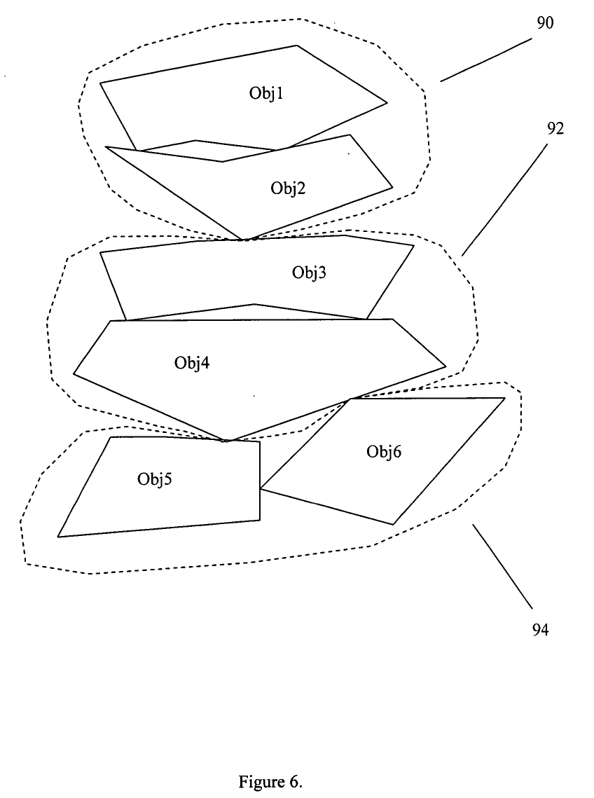

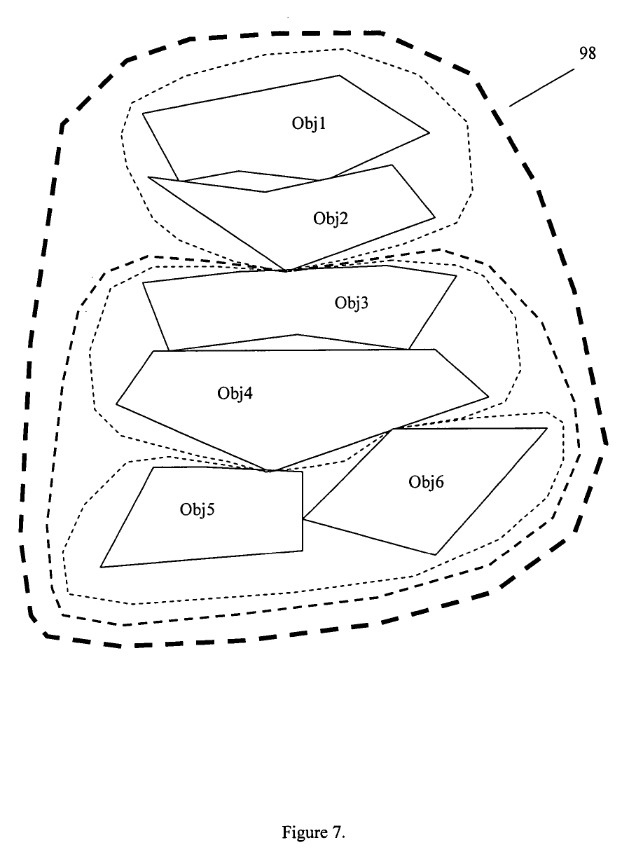

Binary objects, like all other objects, must be able to provide velocity and reaction arrays to the physics system for all external links. The velocity value at any external link of a binary object is simply equivalent to the velocity value of the corresponding sub-object link. Therefore to provide velocity, the binary object need only provide the velocities of the sub-objects at each external link. The procedure for providing a reaction array for a binary object is more involved. In order to provide a reaction array for impulse I on external link Lₓ ( R^{I}ₓ[1 . . . n]), the corresponding reaction array must first be obtained from the appropriate sub-object (the sub-object containing Lₓ). This reaction array is used to set initial cross link delta values. The binary object is then solved to obtain a reactionary impulse solution array I[1 . . . n] as detailed above. The reactionary impulse set values as well as the initial (Lₓ) impulse are next applied to each sub-object and the corresponding reactions are summed at each of the external links to produce the combined reaction (velocity change) values which are then returned as R^{I}ₓ[1 . . . n]. A binary object, therefore, behaves in such a way as to maintain cross link constraints (such as non-penetration) when external impulses are applied. In order to provide a substantially linear solution-time, the dynamics system of the present invention recursively divides a connected object set into smaller sets of binary objects until the set is reduced to a single binary object. FIG. 5 illustrates an example set of objects. Assuming that the links at 80, 82 between Obj3 and Obj4 are known to be broken, impulses must be applied at these links to resolve the breaks. However, impulses must also be applied at the other links in the set to either resolve their broken status or maintain their non-broken status when Obj3 and Obj4 are resolved. In order to resolve the broken links between Obj3 and Obj4 while ensuring the integrity of the other links, the present invention first reduces the set to a single binary object comprising a recursive set of binary objects wherein Obj3 and Obj4 are contained in the sub-objects. A preferred procedure for the reduction of an object set to a recursive binary object is henceforth presented. Initially, a first iteration is performed where adjacent pairs of objects are combined into binary objects, thereby reducing the number of objects in the set to approximately one half. FIG. 6 depicts the first iteration reduction of the example object set in FIG. 5 where the set of six original objects is reduced to the three binary objects at 90, 92, and 94. Adjacent pairs of objects are likewise combined over subsequent iterations until the set is reduced to a single binary object. FIG. 7 depicts the single binary object, 98, resulting from the application of the above mentioned procedure. It should be recognized by those in the art that the connected object set may be reduced to a target binary object in an alternate order and by alternate procedures than those depicted herein. The scope of the present invention does not limit the conversion of a connected object to a target binary object to a specific order nor is the topology of each binary object likewise limited.

Once the target binary object is found, it must be solved to determine the impulse set required to fix the broken cross links. First each sub-object, starting with the most deeply nested binary objects and proceeding outward, is recursively solved to ensure that sub-object links are non-broken. The target binary object is next solved to determine the impulse set required to fix the cross link breaks. The cross link impulses are then applied to the sub-objects. Since the sub-objects are themselves binary objects, impulses applied at the external links will in turn cause reactionary impulses to be applied at each of the sub-objects. In this manner, the proper impulses are applied at all of the links in the object set to maintain their non-broken status. Since all reactions will only be calculated in the direction of the link z-axis and since the reaction values can be considered proportional to the applied force (i.e., R^{x·I}ₐ[b]=x·R^{I}ₐ[b]), reactions need only be calculated once for each link and can be subsequently stored in memory for later use. Because the binary object solution time depends on the maximum number of cross links between any two objects (which can be considered a constant), the number of solution steps is thus linearly dependent on the total number of objects in the object set. The above detailed method of recursively dividing and solving the object set therefore has the advantages of providing a substantially linear solution time as well as being able to provide a solution for any object set topology (i.e., closed loops). More importantly, since solutions and reactions for binary objects at the same depth can be computed in parallel, said recursive method provides the further advantage of a parallelizable solution to an arbitrary object set. Since any connected object set can be reduced to a binary object with a depth at or near the base-2 log of the set size (lg n), a parallel implementation of the above mentioned recursive solution method is able to solve an object set with an O(lg n) time complexity, thereby presenting a dramatic improvement over prior art approaches. Prior art approaches employing LCP/pivoting solutions solve the set in discreet steps rather than at once and therefore cannot be effectively parallelized. Furthermore, recursively based prior art approaches cannot solve for arbitrary set topologies and are likewise unable to maintain contact and/or friction constraints.

To demonstrate an example implementation of the parallel solution mentioned above, consider a system with four processors where each processor is capable of solving a set of linear equations. A recursive binary object is next considered which comprises two binary sub-objects, each of which further comprises two binary sub-objects for a total of eight objects. Each of the four processors then solves each of the four depth-3 binary objects in parallel—calculating both the initial solution and the reactions. This operation can be considered to take a constant amount of time (since the number of cross links in each binary object is substantially constant). Once the depth-3 solutions are calculated, two of the processors are then used to solve each of the two depth-2 binary objects in parallel—likewise taking a constant solution time. Finally, one of the processors solves the single depth-1 binary object (also in constant time), yielding the solution to the system. Thereby a system of eight connected objects is solved within the time frame of three cross link solutions, providing a very fast and efficient solution.

A second aspect of the dynamics system of the present invention is the ability to enforce constraints such as hard contact and friction. Hard contact constraints disallow object interpenetration while ensuring that adhesive force is not used to hold objects together (i.e., only positive impulse is allowed at any link). Some prior art approaches attempt to minimize systems of constraint equations to enforce contact constraints whereas other systems solve the contact constraints as a linear complementary problem (LCP). Either approach can lead to a high order solution complexity in some cases. In order to ensure a parallelizable, substantially linear time solution for implementing hard contact constraints, the dynamics system of the present invention calculates a set of link weights which produce a solution adherent, within a tolerance, to the contact constraints. Since the correct set of link weights cannot be known a priori for a particular configuration, the dynamics system of the present invention iteratively adjusts the set of link weights over multiple solutions. A preferred method of the present invention for implementing contact constraints for a given object set is detailed below. Initially, all link weights are set to 0.5. The object set is then repeatedly solved over two or more iterations. At each iteration, the link weights are increased by a set amount for all links with a total impulse greater than zero. Likewise, link weights are decreased for all links with a total impulse less than zero. After each iteration, constraint violation error values (such as maximum interpenetration velocity and maximum negative impulse) are calculated. If the constraint violation errors are acceptably small (i.e., below a set tolerance), the process is terminated and the impulse and weight values from the last solution are used. The process can likewise be terminated after a set number of iterations. In addition, per-iteration weight adjustment can be directionally skewed to favor the maintenance of one constraint over the other. For example, weight values can be set to only increase after a set iteration is reached—thereby ensuring the non-penetration constraint is completely satisfied at the expense of the non-negative impulse constraint. The practice of iteratively adjusting link weights gives the dynamics system of the present invention several advantages over prior art approaches. Chiefly, said practice enables the estimation of a dynamics solution, within a selectable level of accuracy, while retaining the ability to completely enforce certain constraints (such as non-penetration). Furthermore, said practice enables the ability of a dynamics solver to implement constraints which vary continuously over a set of inputs (such as velocity or force), consequently resulting in a dramatic increase in the types of behaviors that can be simulated.

Friction constraints are generally more difficult to enforce in dynamics systems. In order to accurately simulate physical interaction, constraints for both static and dynamic friction must be enforced. Both types of friction involve a frictional force/impulse applied at the lateral plane of contact (the X/Y plane of the link orientation) and are subject to the constraints that the relative lateral motion between the objects is zero or that the frictional force is equal to the total normal force scaled by a friction coefficient. In many prior art approaches, dynamic friction constraints are solved in a manner distinct from static friction and can consequently lead to unsolvable systems. The present invention provides a system to handle static and dynamic friction constraints in the same manner whereby unsolvable systems are not introduced.

In order to implement frictional constraints in the present invention, the above detailed binary object solution method must be amended to solve each link along all three axes rather than only the z-axis. In order to solve on all three axes, function t(x) is first defined where:
t(x)=(x+2)/3: x mod 3=1 (14)
t(x)=(x+1)/3: x mod 3=2 (15)
t(x)=x/3: x mod 3=0 (16)
Vector array P[1. . . 3n] is further included wherein:
P[x]=Cₜ₍ₓ₎.X: x mod 3=1 (17)
P[x]=Cₜ₍ₓ₎.Y: x mod 3=2 (18)
P[x]=Cₜ₍ₓ₎.Z: x mod 3=0 (19)
The initial delta array d is redefined as d[1. . . 3n] wherein each element is defined as:
d[x]=Cₜ₍ₓ₎.D·P[x] (20)
Likewise the combined reaction value array B is redefined as follows:
B[x,y]=(FrontOBJ.R^{-P[x]}ₜ₍ₓ₎[t(y)]−BackOBJ.R^{P[x]}ₜ₍ₓ₎[t(y)])·P[y] (21)
In addition, each link is expanded to include three scalar weight values (Wx, Wy, Wz) corresponding to each of the three link axes. The w array is consequently redefined as:
w[a]=Cₜ₍ₐ₎.Wx: a mod 3=1 (22)
w[a]=Cₜ₍ₐ₎.WY: a mod 3=2 (23)
w[a]=Cₜ₍ₐ₎.WZ: a mod 3=0 (24)
The A and J arrays remain as previously defined whereas the k array is henceforth redefined as:

$$\begin{matrix}\begin{matrix}k [ p ] = J [ p , p ] + {\sum }_{q ← p + 1}^{3 n} ( J [ q , q ] \cdot J [ p , q ] ) \text{:} & 1 \leq p < 3 n\end{matrix} & ( 25 ) \\ \begin{matrix}k [ p ] = J [ p , p ] \text{:} & p = 3 n\end{matrix} & ( 26 )\end{matrix}$$

The final impulse vectors, 1[1. . . n], are lastly determined by:
I[x]=(k[x]·P[x])+(k[x+1]·P[x+1])+(k[x+2]·P[x+2]) (27)
The above detailed modified binary object solution method is functionally the same as the previously defined solution method with the exception that variables are given for each of the three axes (X, Y, and Z) rather than only the z-axis. Likewise, the distinguishing point of the above detailed method is the use of one or more substantially continuous link weights for each link. Therefore, the above detailed preferred solution method may thus be altered or superseded within the scope of the present invention provided that link weights are handled in a functionally similar manner.

A preferred method of the present invention for implementing contact and friction constraints for a given object set is henceforth detailed. As with contact constraints, link weight values are iteratively adjusted over multiple solutions. Initially, all link weights (Wx, Wy, and Wz) are set to 0.5. After each iteration, link weights are adjusted based on the impulse applied. Link weight z values (Wz) are adjusted based on the z-axis (normal) impulse as previously detailed wherein positive impulse increases the weight while negative impulse decreases it. Lateral link weights (Wx, Wy) are adjusted to produce the proper lateral impulse in relation to the normal impulse and coefficient of friction. With N being the total normal impulse, F being the total lateral impulse, and c being the coefficient of friction for a given link, the adjusted x-axis link weight value (Wx′) is calculated from the previous x-axis value (Wx) and z-axis value (Wz) by:

$${Wx}^{′} = \frac{c \cdot N \cdot Wx}{F \cdot Wz} \qquad ( 28 )$$

The Wx′ value is then clamped to a zero-to-one range. Alternate embodiments additionally limit the maximum change in link weight for each iteration. The Wy′ value is then set equal to Wx′. After each iteration, friction constraint error values (such as the largest difference between applied friction impulse and optimal impulse) are calculated along with the aforementioned contact constraint error values. The process may then terminate when all error values are below a preset tolerance or when the number of iterations reaches a preset maximum. Once the process is terminated, impulse and weight values from the current iteration are used as the final results. Since static and dynamic friction are both enforced by the lateral link weights and since link weights, at most, reduce the relative velocity to zero, the maintenance of dynamic and static friction constraints by the use of link weights, therefore, cannot introduce insolvability into the system. Alternate embodiments, as will be recognized by those in the art, use other methods to calculate adjusted link weight values at each iteration including, but not limited to, quadratic and cubic estimation strategies.

A further aspect of the present invention in relation to the previously detailed iterative approach to constraint maintenance is the ability of any object in the system to maintain internal constraints wherein said constraints may vary continuously with the impulse applied to the object. Specifically, during each solution iteration, an object may alter its internal behavior, and thus its reaction(s), dependent on the total impulses applied. This is, in essence, what binary objects do through the adjustment of link weights. The mechanism of altering behavior at each iteration, however, is not limited to binary objects. Within the present invention, other objects may implement said mechanism to simulate complex behaviors which has been heretofore difficult or impossible to implement in prior art dynamics systems. As an example, consider a large structure such as a bridge represented by a single object comprised of a number of connected pieces. With nominal force applied, the pieces of the bridge remain firmly connected and the bridge is immobile, thereby producing a zero reaction (since the forces will not change the velocity of any part of the bridge). If a larger force is applied, and the tension between some of the connected pieces becomes greater than a pre-set maximum, the bridge can break at some of the connections producing an alternate reaction with the broken pieces moving from the applied force. In a likewise manner, collisions between multiple breakable objects can be simulated, with each object breaking realistically under the collision forces, thereby providing a more realistic and immersive gaming experience to the end user.

While the detailed description above teaches the applicability of a weight-based iterative solution method to the resolution of contact and frictional constraints over points of hard contact between objects, it should be noted that said solution method is likewise applicable in solving alternate types of constrained links between objects. For example, links wherein all link weight values are set to one are functionally equivalent to rotation joints with three degrees of freedom. Likewise a link with a weight of one along the normal direction is able to implement a point on surface contact constraint. Breakable constraints can also be solved by the above mentioned iterative solution method where, for example, link weights are initially set to one but are reduced on subsequent iterations if the net impulse on the link is greater than a predetermined limit value. A further beneficial aspect of the present invention is the ability of individual objects to implement alternate constraints by any method while interactions with other objects are able to be handled by the above mentioned solution method. For example, an object may comprise a multi-jointed body (such as a humanoid figure) wherein algorithms local to the object control the behavior and resolution of the joints. Provided that the object's internal behavior (when impulses are applied) is consistent with the behavior implied through its reaction(s), said object is able to interact with other objects (such as rigid bodies) through the above detailed solution methods. Said methods are likewise applicable to handle internal collisions within an object without inherent modification of the object behavior (i.e., the same reaction algorithm can be used for both internal and external contact links).

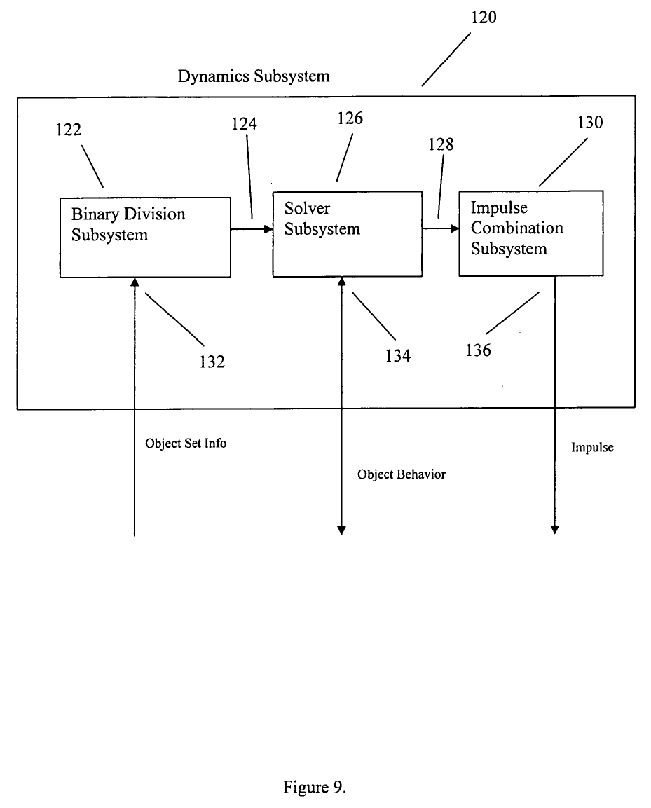

FIG. 9 depicts a logical view of the dynamics subsystem 120 of the game system of the present invention. The purpose of the dynamics subsystem is, given one or more connected object sets, to produce a set of link impulses such that application of said impulse sets shall substantially maintain one or more constraints, such as non-penetration and/or friction, between objects in said connected object set(s). At 132, object set information is provided to a binary division subsystem 122 operable to convert one or more connected object sets into recursive binary objects as previously detailed. In some embodiments, multiple processors are utilized by the binary division subsystem to reduce the conversion time required by large connected object sets. Recursive binary object data is then passed at 124 to a solver subsystem 126 wherein said subsystem is operable to iteratively compute solution impulse sets for one or more binary objects. In a preferred embodiment, the solver subsystem comprises multiple processors to simultaneously compute solution and reaction impulse sets for multiple binary objects. The solver subsystem iteratively solves the given binary object(s) wherein link weight values are adjusted at each iteration as previously defined. In order to incorporate object polymorphism and iterative object behavior modification, object behavior data is transferred to and from the solver subsystem at 134. Impulse set and object reaction information is transferred at 128 to an impulse combination subsystem 130. The impulse combination subsystem is operable to combine external and cross link impulse values for one or more binary objects to produce a set of total impulse values for substantially each link in a connected object set. Some embodiments employ multiple processors to decrease the time taken to calculate said total impulse value set. The set of total impulse values is then output from the dynamics subsystem at 136.

While the dynamics system of the present invention has been detailed herein using the examples of impulse and velocity, it should be noted by those in the art that the use of said system for the solution of object sets where impulse is replaced by force and velocity by acceleration is functionally equivalent with a few distinctions. Firstly, while the aforementioned cross-link delta values (d[1. . . n]) designate differences in acceleration rather than velocity, exceptions are made in the case of dynamic friction. For links with a non-zero relative lateral velocity (i.e., links subject to dynamic friction), said lateral velocity should be scaled and combined with the lateral acceleration in the cross-link delta value(s) to represent the effects of the acceleration over a set time period (such as frame length). Likewise in links with a negative relative normal velocity (where the linked objects are moving apart), a scaled normal velocity may be combined with the relative normal acceleration value in the cross-link delta. Using the aforementioned combined cross link normal delta will ensure no force is applied at links with a negative velocity past a set limit while force is still applied at links with negligible relative velocities, thereby avoiding redundant solutions.

The detailed description presented herein teaches a system and method whereupon physical interactions are simulated among an arbitrary set of objects in a low-order time frame with respect to the total number of objects in the set and wherein hard contact and friction constraints are maintained. It should be noted by those in the art that methods and operations detailed above are presented herein for the purpose of example and may thus be modified and/or optimized to an extent without departing from the scope of the present invention as defined by the appended claims and equivalents. It should also be noted that the game system of the present invention and the various subsystems presented therein may be implemented as software instructions running on a general purpose CPU and/or by custom computer hardware dedicated to performing one or more of the above-identified operations without departing from the scope of the invention.

It is therefore intended that the foregoing detailed description be regarded as illustrative rather than limiting, and that it be understood that it is the following claims, including all equivalents, that are intended to define the spirit and scope of this invention.

1. A method of simulating physical dynamics of a predetermined set of objects that are part of a computer/video game, the objects connected to each other at one or more respective links, with at least one link representing a hard contact between separate objects, the method comprising:
a. grouping a first and a second object in the predetermined set of objects to define a first binary object;
b. solving a solution for the physical dynamics of the objects in the first binary object at a first set of links;
c. grouping a third object to the first binary object to define a second binary object, the third object having at least one link to the first binary object, thereby defining a second set of links;
d. solving a solution for the physical dynamics of the objects in the second binary object at the second set of links; and
e. recursively grouping additional objects to create additional binary objects and solving for the physical dynamics of the additional binary objects.

2. The method of claim 1 including the step of providing, for each link, one or more link weight values operable to constrain the solution.

3. The method of claim 2 further including the step of performing multiple iterative solutions where at least one link weight value is adjusted at each iteration.

4. The method of claim 3 where the link weight values are adjusted to maintain a set of constraints on the links within a predetermined acceptable tolerance.

5. The method of claim 4 where the set of constraints includes the following constraints: the objects cannot interpenetrate each other and no adhesive normal forces are applied at the links.

6. The method of claim 5 where the predetermined acceptable tolerance includes a predetermined amount of interpenetration at a link.

7. The method of claim 6 where the predetermined acceptable tolerance includes a predetermined amount of adhesive normal force at a link.

8. The method of claim 7 where the set of constraints further includes the constraint that, at a respective link, either the relative lateral motion is zero or the friction force at the link is equal to the normal force times the coefficient of friction.

9. The method of claim 8 where the predetermined acceptable tolerance includes a predetermined difference between the friction force at a link and the normal force times the coefficient of friction.

10. A method of simulating physical dynamics of a predetermined set of objects that are part of a computer video game, the objects connected to each other by at least one respective link, and where at least one object is not a rigid body, the method comprising
a. providing, for at least one object, a set of reaction values describing the motion of the object in response to applied forces;
b. solving a solution to the physical dynamics of the set of objects using the reaction values;
c. changing the reaction values for at least one object to provide a set of adjusted reaction values;
e. solving a solution to the physical dynamics of the objects using the set of adjusted reaction values; and
f. repeating steps c and e until the solution is within a predetermined acceptable tolerance.

11. The method of claim 10 further including the step of creating a nested grouping of a plurality of binary objects from the objects in the set.

12. The method of claim 11 where the step of solving a solution for the physical dynamics of the objects includes the step of starting with the most deeply nested binary object and proceeding outward, solving a solution for the physical dynamics of the objects in the binary objects at the respective links.

13. The method of claim 12 further including the step of providing, for each link, one or more link weight values operable to constrain the solution.

14. The method of claim 13 where the step of changing the reaction values for at least one object further includes the step of adjusting at least one link weight value.

15. The method of claim 14 where the link weight values are adjusted to maintain a set of constraints on the links within a predetermined acceptable tolerance.

16. A method of simulating physical dynamics of a predetermined set of objects that are part of a computer/video game, the objects connected to each other at one or more respective links, with at least one link representing a hard contact between separate objects, the method comprising:
a. grouping the objects in the predetermined set of objects into two binary objects to define a first binary object and a second binary object;
b. grouping the objects in the first binary object into a subgroup of binary objects to define a nested group of binary objects in the first binary object;
c. grouping the objects in the second binary object into a subgroup of binary objects to define a nested group of binary objects in the second-binary object; and
d. starting with the most deeply nested binary object and proceeding outward, solving a solution for the physical dynamics of the objects in the binary objects at the respective links.

17. The method of claim 16 including the step of providing, for each link, one or more link weight values operable to constrain the solution.

18. The method of claim 17 further including the step of performing multiple iterative solutions where at least one link weight value is adjusted at each iteration.

19. The method of claim 18 where the link weight values are adjusted to maintain a set of constraints on the links within a predetermined acceptable tolerance.

20. The method of claim 19 where the set of constraints includes the following constraints: the objects cannot interpenetrate each other and no adhesive normal forces are applied at the links.

21. The method of claim 20 where the predetermined acceptable tolerance includes a predetermined amount of interpenetration at a link.

22. The method of claim 21 where the predetermined acceptable tolerance includes a predetermined amount of adhesive normal force at a link.

23. The method of claim 22 where the set of constraints further includes the constraint that, at a respective link, either the relative lateral motion is zero or the friction force at the link is equal to the normal force times the coefficient of friction.

24. The method of claim 23 where the predetermined acceptable tolerance includes a predetermined difference between the friction force at a link and the normal force times the coefficient of friction.

25. A method of simulating the physical dynamics of a predetermined set of objects that are part of a computer/video game, the objects connected to each other at one or more links, at least one object represented by a plurality of polygons, the method comprising:
a. creating a nested grouping of a plurality of binary objects from the objects in the set, at least one binary object containing two or more links; and
b. starting with the most deeply nested binary object and proceeding outward, solving a solution for the physical dynamics of the objects in the binary objects at the respective links.

26. The method of claim 25 where the solution maintains a set of constraints on the links within a predetermined acceptable tolerance.

27. The method of claim 26 where the set of constraints includes the following constraints: the objects cannot interpenetrate each other and no adhesive normal forces are applied at the links.

28. The method of claim 27 where the predetermined acceptable tolerance includes a predetermined amount of interpenetration at a link.

29. The method of claim 28 where the predetermined acceptable tolerance includes a predetermined amount of adhesive normal force at a link.

30. The method of claim 29 where the set of constraints further includes the constraint that, at a respective link, either the relative lateral motion is zero or the friction force at the link is equal to the normal force times the coefficient of friction.

31. The method of claim 30 where the predetermined acceptable tolerance includes a predetermined difference between the friction force at a link and the normal force times the coefficient of friction.

32. The method of claim 31 including the step of providing, for each link, one or more link weight values operable to constrain the solution.

33. The method of claim 32 further including the step of performing multiple iterative solutions where at least one link weight value is adjusted at each iteration.

34. A method of simulating the physical dynamics of a predetermined set of objects that are part of a video game, the objects connected to each other at at least one respective link, the method comprising:
a. providing set of equations that when solved define a solution to the physical dynamics of the set of the predetermined set of objects, the solution having the following constraints: the objects cannot interpenetrate each other and no adhesive normal forces can be applied at the links;
b. assigning at least one link weight to each of the links in the predetermined set of objects;
c. solving an iterative solution for the physical dynamics of the objects using the assigned weights;
d. adjusting the assigned link weights if the constraints are violated at a link;
e. solving an iterative solution for the physical dynamics of the objects using the adjusted weights; and
f. repeating steps d. and e. until a solution is within a predetermined acceptable tolerance.

35. The method of claim 34 wherein the predetermined acceptable tolerance includes a predetermined amount of adhesive normal force at a link.

36. The method of claim 35 wherein the predetermined acceptable tolerance includes a predetermined amount of interpenetration between two objects at a link.

37. The method of claim 36 wherein the weights are decreased for links where adhesive normal force is applied.

38. The method of claim 37 wherein the weights are increased for links where interpenetration occurs.

39. A method of simulating the physical dynamics of a predetermined set of objects that are part of a video game, the objects connected to each other at one or more respective links, the method comprising:
a. providing a set of equations that when solved define a solution to the physical dynamics of the set of the predetermined set of objects, the solution having the following constraints: the objects cannot interpenetrate each other and no adhesive normal forces can be applied at the links, and that, at a respective link, either the relative lateral velocity is zero, or the friction force is equal to the normal force at the link times the coefficient of friction;
b. assigning at least one link weight to each of the links in the predetermined set of objects;
c. solving an iterative solution for the physical dynamics of the objects using the assigned weights;
d. adjusting the link weights assigned to the links if the constraints are violated at a link;
e. solving an iterative solution for the physical dynamics of the objects using the adjusted weights; and
f. repeating steps d. and e. until a solution is within a predetermined acceptable tolerance.

40. The method of claim 39 wherein the predetermined acceptable tolerance includes a predetermined amount of adhesive normal force at a link.

41. The method of claim 40 wherein the predetermined acceptable tolerance includes a predetermined amount of interpenetration between two objects at a link.

42. The method of claim 41 where the predetermined acceptable tolerance includes a predetermined difference between the friction force at a link and the normal force times the coefficient of friction.

43. The method of claim 42 wherein the weights are decreased for links where adhesive normal force is applied.

44. The method of claim 43 wherein the weights are increased for links where interpenetration occurs.

45. A system for simulating the physical dynamics of a set of objects within a video game, the objects connected to each other at one or more respective links, the system comprising:
a. a binary division unit having logic operable to creating a nested grouping of a plurality of binary objects from the objects in the set; and
b. a dynamics unit having logic operable to solve a set of physical dynamics equations.

46. The system of claim 45 where the dynamics unit comprises a set of multiple processors, each processor operable to solve a set of physical dynamics equations.

47. The system of claim 46 where said multiple processors are used to solve the dynamics equations of multiple binary objects in parallel.

48. The system of claim 47 where each link includes one or more link weight values operable to constrain the solution.

49. The system of claim 48 where the dynamics unit further comprises logic operable to perform multiple iterative solutions wherein one or more link weight values are adjusted at each iteration.

50. The system of claim 49 where the link weight values are adjusted to maintain a set of constraints for each link within a predetermined tolerance.

51. The system of claim 50 where said set of constraints includes the following constraints: the objects cannot interpenetrate each other and no adhesive normal force is applied.

52. The system of claim 51 where the set of constraints further includes the constraint that, at a respective link, either the relative lateral motion between the objects is zero or the friction force at the link is equal to the normal force multiplied by the coefficient of friction.
